(19) United States
(12) Patent Application Publication
(10) Pub. No.: US 2015/0377373 A1
(43) Pub. Date: Dec. 31, 2015

(54) Butterfly Valve Comprising Removable Coupling Part

(71) Applicant: SITEK AS, Hauglandshella (NO)

(72) Inventor: Frank BORGE, Hauglandshella (NO)

(21) Appl. No.: 14/766,174

(22) PCT Filed: Feb. 4, 2014
(86) PCT No.: PCT/NO2014/000013

§ 371 Date: Aug. 6, 2015

(30) Foreign Application Priority Data
Feb. 6, 2013 (NO) 20130199

(51) Int. Cl. F16K 27/02; F16K 1/226

(52) U.S. Cl. CPC F16K 27/0218; F16K 1/2265

(57) ABSTRACT

A soft-sealing, concentric butterfly valve (10) for mounting with couplings or flanges is described, comprising a valve housing (12) with a through running boring (14), in which a rotary damper (16) is mounted to a spindle (18) and is arranged standing in a circular-cylindrical valve seat (20) and the valve seat (20) is equipped internally with conical contact surfaces (20a) for the damper (16). The valve housing (12) comprises on a first side (12a) a coupling end piece (22) and the valve housing (12) is on the opposite side (12b) equipped, with several threaded bolt holes (24) arranged radially around the through running boring (14). A removable coupling part (40) comprising a second end coupling piece (42) is fitted to the other side (12b) of the valve housing (12) and the coupling part (40) is fastened to the valve housing (12) with the help of bolts (50) inserted in the threaded bolt holes (24), and also that the valve seat (20) is placed between the valve housing (12) and the coupling part (40) and surrounds the damper (16).

The present invention relates to a butterfly valve far mounting with couplings or flanges, comprising a valve housing with a through running boring, in which a rotary damper, mounted to a spindle, is arranged standing in a circular-cylindrical valve seat and where the valve seat is equipped internally with conical contact surfaces for the damper. Furthermore, the valve housing comprises, on a first side, a coupling end piece and the valve housing is, on the opposite side, equipped with several threaded bolt holes arranged radially around the through running boring.

Today, it is common to use lug type butterfly valves with threaded bore holes on both sides of the valve. This is a well tried embodiment which is approved by the classification societies. However, the fitting is labour intensive as one must first weld flanges onto the pipe ends. Thereafter, the valve is centred on the flange and bolts are tightened. The most common valves are also vulnerable to poor centring or damages to the flange. If the fitting procedures are net followed accurately, there will be a risk for leaks and damages.

In addition, this is a time consuming and thus a costly procedure. On a modern PSV vessel (platform supply ship), there are about 250 tonnes of pipe and pipe parts so that the piping work is one of the most labour intensive and costly jobs for a such new construction, and particularly within the ship building industry there is a considerable saving potential.

Couplings have been on the market for many years, but have, in the main, been used within fire protection/sprinklers and plumbing, beating and sanitation. Lately, there has been only limited industrial application before now, as Norwegian shipyards have over the last years started to use couplings to a larger extent. Focus on savings in time and thereby costs have provided an opening for this type of equipment. Today, there are two large suppliers of couplings in the Norwegian market.

As mentioned, there are today a good selection of equipment and parts for firs protection/sprinklers and plumbing, heating and sanitation, including valves suitable for such application areas. However, there are no valves for this type of coupling that is suitable for use within ship building and the market is asking for such valves. The valve according to the invention has a particular application within the ship building industry, but can be used in general within any industry and is thus not limited to the ship building industry.

All the valves one knows for fitting with couplings have in common that the sealing is in the form of a vulcanised rubber covering on the damper. The valve housing is covered with an epoxy compound or similar surface treatment. This makes the valve vulnerable to damages in the coveting both to the housing and the damper. The risk of corrosion and subsequent leakage is regarded as relatively large.

Valve types with coupling ends on both sides are not suited to fitting to the side of a ship. A number of standard lug valves are used together with flange adapters for the fitting. This is expensive equipment and not particularly suited to fitting of standard dampers.

The valve according to the invention is a soft-sealing, concentric butterfly valve which is leak proof, often with a two-sided seal. Furthermore, it can have a through running spindle fastened to the damper via a spline, square peg or taper pins. Dry spindle, isolated from the medium.

The components of the soft-sealing butterfly valve according to the invention are placed in a new housing with an end piece for fitting to a coupling, such as a mechanical grooved coupling. It is thus not a quick coupling, but a fast mechanical connection with bolts that are tightened to secure the coupling. Examples of pressure classification can be up to 64 bar for the coupling and 25 bar for the valve.

the valve seat of different materials can be mounted on or vulcanised on a hard insertion ring or support ring. The valve seat can have conical contact surfaces for the damper at the through running of the spindle and also integrated sealing rings in the opening for the running through of the spindle. This ensures a leak proof construction without the use of extra O-rings.

The valve can have a metal damper in different materials with a machined sealing surface.

The valve housing according to the invention is preferably cast in two parts. A main part can have an end pipe piece for a coupling on the one side and a standard lug embodiment with threaded bolt holes on the other side. At the fitting of the lug side against the flange, the valve will be able to be mounted to the side of the ship, to flanged pipe parts or components such as filters, pumps, etc. Mounted on this way the valve can function as a blinding of a pips line.

According to the invention a second part in the form of an end piece, can be in the form of a flanged pipe end piece where the flange boring is adapted to the boring of tine lug side of the valve. The pipe end is preferably grooved for mounting with couplings. The valve housing can have an ISO standardised top flange that makes a direct fitting of an activator possible. The valve housing has a standard short neck, but can be supplied with a long neck adapted to the isolation of pipelines.

A valve according to the invention can have a type of valve seat that seals against a counter flange without the use of additional gaskets. The contact edge in the main part of the valve housing can function as a sealing surface. &hen the end piece of the valve housing or a standard counter flange is mounted on the main part, the valve seat is compressed between these parts so that a leak proof connection is created in all joints.

Consequently, it is an object to provide a valve and then in particular a butterfly valve as described above.

From prior art, reference is made to, among others, U.S. Pat. No. 6,125,871 which shows a chemical fluid transfer valve (for example, for loading/unloading of bulk materials) and which is formed by a male valve assembly and a female valve assembly. This relates to a composed sampling valve with a flushing solution based on loose components and quick couplings. The butterfly valve is here a standard wafer valve for insertion between the flanges. US 2011163532 A1 show a hose coupling for a fire engine and a method for the use of the system. The hose coupling is in the form of a quick coupling that makes it possible to get a quick connection between the fire hose and the fire engine, and even more importantly is that the system makes it possible to disconnect even faster.

Concerning the above mentioned documents, it shall be pointed out that in general both solutions relate to quick couplings. The present invention relates, as mentioned, not to a quick; coupling, which will be clear in the sense that the valve housing and the coupling part shall be screwed together, i.e. a solid mechanical connection with bolts that are tightened to secure the coupling. Furthermore, the valve according to the invention is a soft-sealing, concentric butterfly valve which is leak proof, usually with a two-sided seal.

The above mentioned objects are obtained with a butterfly valve as given in the independent claim, while alternative embodiments are given in the respective dependent claims.

According to a first aspect of the invention, a butterfly valve is provided for mounting with couplings or flanges, comprising a valve housing with a through running boring, in which a rotary damper mounted to a spindle is placed standing in a circular-cylindrical valve seat, and that the valve seat inside is equipped with conical contact surfaces for the damper. On a first side, the valve housing comprises a coupling end piece and the valve housing is mounted on the opposite side with several threaded bolt holes arranged radially about the through running boring. The valve is characterised in that a removable coupling part comprising a second coupling end piece is mounted to the other side of the valve housing and that the coupling part is fastened to the valve housing with the help of bolts inserted into the threaded bolt holes, and also that the valve seat is inserted between the valve housing and the coupling part and surrounds the damper.

It is preferred that the coupling end piece is cast in one piece with the valve housing.

The spindle is preferably running through the valve seat and the valve seat can comprise integrated sealing rings in the openings for the through running of the spindle.

The removable coupling part preferably comprises a boring with a similar or identical diameter to the boring in the valve housing.

Furthermore, the valve housing can be equipped with a neck encompassing a collar, and an upper part of the spindle can extend above the collar and make up a rotation pivot. The valve housing can also comprise, on one or both sides of the damper, bushes or bearings for the mounting of the spindle.

The valve housing can also comprise an internal edge, against which the valve seat lies, where said edge and a contact surface for a flange connection or the second coupling part can function as sealing surfaces, as the valve seat is compressed between these parts to provide a leak proof connection.

Furthermore the butterfly valve according to the invention can be surface treated by hot-dip galvanisation.

The invention shall now be described in more detail with help of the enclosed figures, in which

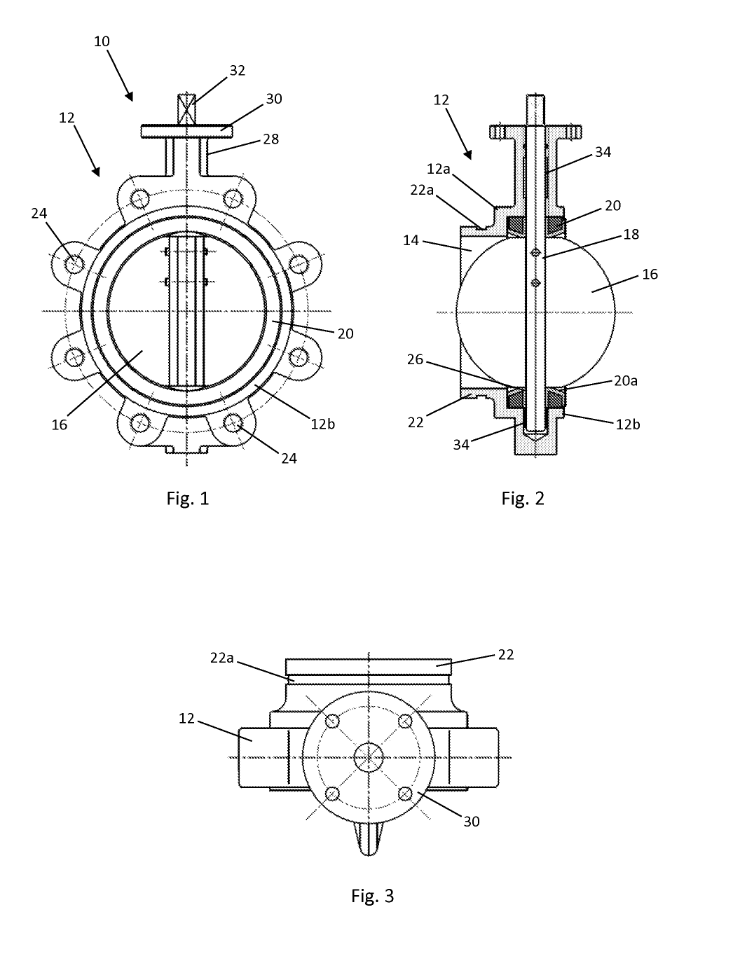

FIG. 1 shows an outline of a butterfly valve according to the invention.

FIG. 2 shows a section of the butterfly valve according to the invention.

FIG. 3 shows a top outline of the butterfly valve shown in FIGS. 1 and 2.

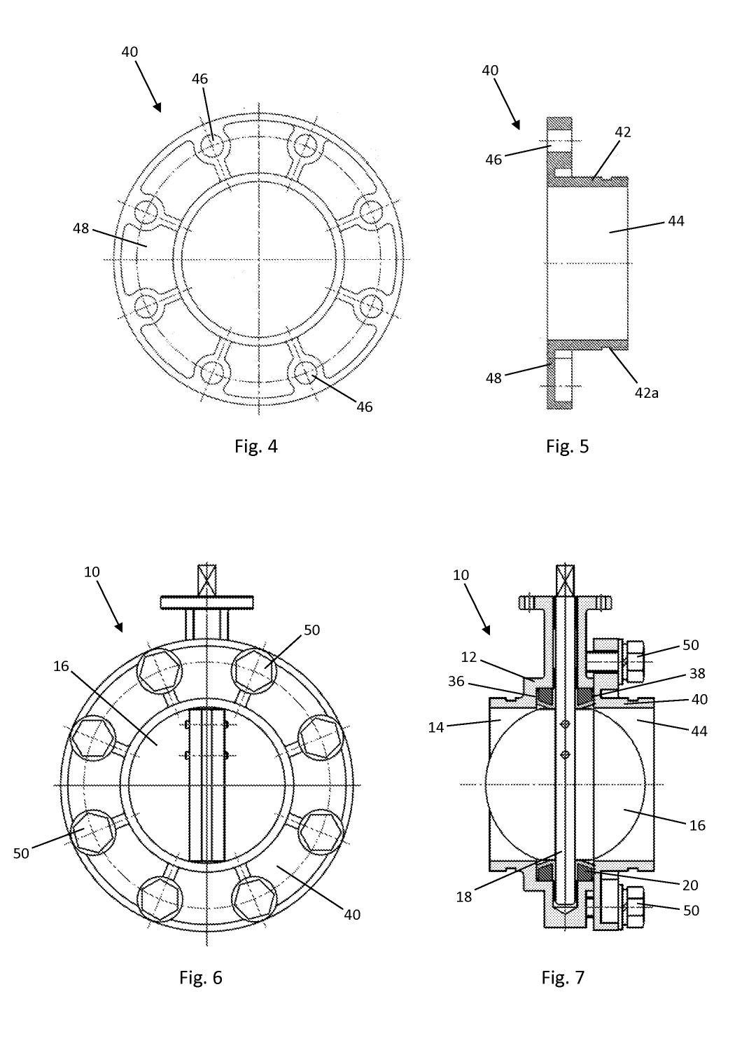

FIG. 4 shows an outline of a removable coupling part according to the invention.

FIG. 5 shows a section of the removable coupling part according to the invention.

FIG. 6 shows an outline of the butterfly valve according to the invention.

FIG. 7 shows a section of the butterfly valve according to the invention.

FIGS. 1-3 show a valve housing 12 of a butterfly valve 10 according to the invention. The valve housing 12 comprises in an, in the main, traditional way a spindle 18 that extends vertically through most of the valve housing. A damper 16 is arranged standing in a through running boring 14, where the damper is fitted to the spindle 18. The spindle 18, and thus the damper 16, can be rotated either manually or automatically with the help of an activator (not shown). For example, an upper end 32 of the spindle that extends out of or extends above the valve housing 12 can function as a rotation pivot and is activated for rotation of the damper 16 so that flow through the valve housing is regulated. The valve housing 12 can comprise, on one or both sides of the damper 16, bushes or bearings 34 for the mounting of the spindle 18.

Furthermore, a valve seat 20 is arranged in the boring 14 and around the damper 16, where the valve sear can be formed in an, in the main, circular-cylindrical form and in various materials and which can be cast in a sealing material and/or which can be fitted on or vulcanised on a hard insert ring or support ring (for example, as illustrated in FIG. 2). The valve seat 20 can have conical contact surfaces 20a for the damper 16 at the through running of the spindle and also integrated sealing rings 26. The valve seat 20 can also be cast, for example, in one piece of plastic or rubber. Furthermore, the valve seat 20 lies against an inner edge in the valve housing 12 and a second (not shown) part can provide a corresponding edge which the valve sear 20 can lie against.

The damper 16 is formed, in principle, in a round shape with an external diameter that corresponds with the inner diameter of the valve seat 20, but where the damper at the through running of the spindle is formed with respective bevelled and flat top and bottom sections.

The upper part of the valve can comprise, in a known way, a neck 28 and a top flange 30.

A first side 12a of the valve housing 12 comprises a coupling end piece 22 for connection and can comprise an external circular groove 22a for fitting to the coupling. A second side 12b comprises a coupling surface with several threaded bolt holes 24 arranged radially about the boring 14. Thereby, the invention as shown in the FIGS. 1-3, can be connected to a coupling on the one side and to a standard flange connection (not shown), or the like, to a pipe on the other side. The FIGS. 4 and 5 show a second coupling part 40 for use together with the valve housing 12. The coupling part 40 comprises a pipe piece in the form of a coupling end piece 42 for connecting. In a corresponding way, the coupling end piece 42 can be fitted with an external circular groove 42a. The coupling part 42 further comprises a flange-like connection 48 fitted with several belt holes 46, where the placing of the bolt holes 46 corresponds to the belt holes 24 in the valve housing 12, i.e. with the same radial centreline.

The FIGS. 6 and 7 show the coupling part 40 fitted to the valve housing 12. In this preferred embodiment the butterfly valve according to the invention can be used between two couplings in a pipe system. As shown in the figures, the coupling part 40 is securely belted with the help of the bolts 50 that run through the bolt holes 24 in the flange part 48 of the coupling part 40 and which are screwed into the threaded bolt; holes 24 of the valve housing 12. Thus, this provides a butterfly valve with two opposite coupling ends. Alternatively, the coupling part 40 can be fastened in other ways or with other means to the valve housing 12 than those shown in the figures. It can also be imagined that the coupling part can be cast integrated with the valve housing in one piece.

The valve seat 20 lies, as shown, against an inner edge 36 in the valve housing 12 and the second coupling part 40 provides a corresponding edge 38 against which the valve seat 20 lies. Thus, the valve seat 20 is inserted between the valve housing 12 and the coupling part 40 and surrounds the damper 16. Thereby, the valve seat 20 seals without the use of an additional gasket as the edge 36 in the valve housing 12 and the contact surface 38 of the coupling part 40 can function as sealing surfaces so that the valve seat gets compressed between these two parts and a watertight connection in all joints is achieved. The corresponding will be relevant at the use of a standard flange connection instead of the second coupling part, as described above.

furthermore, the valve seat will be able to isolate the valve housing and this is something that can contribute to removing internal wear in the housing.

The butterfly valve can be supplied in a hot-dip galvanized embodiment, in, for example, a ballast system, hot-dip galvanisation is a common surface treatment of components. The valve with the coupling ends is both a valve and a piece of the pipe system and a corresponding surface treatment of the valve could therefore be an important feature. Previously, it has not been common that valves for use in such pipe systems have been supplied in hot-dip galvanised embodiments.

It shall also be mentioned that the coupling parts 22,42 can alternatively be connected to the pipes in the pipe system with the help of a loop coupling, i.e. a loop that can be tightened with the help of a rotary lifting arm and is securely locked in a tightened position. The intended loop coupling is not a real quick coupling, but a coupling intended for use in installation areas where pips routes are often re-laid.

1. Soft-sealing, concentric butterfly valve (10) for mounting with couplings or flanges, comprising a valve housing (12) with a through running boring (14), in which a rotary damper (16), mounted to a spindle (18), is arranged standing in a circular-cylindrical valve seat (20), and that the valve seat (20) is equipped internally with conical contact surfaces (20a) for the damper (16),
the valve housing (12) comprises on a first side (12a) a coupling end piece (22) and the valve housing (12) is on the opposite side (12b) equipped with several threaded bolt, holes (24) arranged radially around the through running boring (14),
characterised in that a removable coupling part (40), comprising a second coupling end piece (42), is mounted to the other side (12b) of the valve housing (12), and that the coupling part (40) is fastened to the valve housing (12) with the help of bolts (50) inserted in the threaded bolt holes (24), and also that the valve seat (20) is placed between the valve housing (12) and the coupling part (40) and surrounds the damper (16).

2. Butterfly valve (10) according to claim 1, characterised in that the coupling end piece (22) is cast in one piece with the valve housing (12).

3. Butterfly valve (10) according to claim 1, characterised in that the spindle (18) runs through the valve seat (20), and that the valve seat (20) comprises integrated sealing rings (26) in the openings for the through running of the spindle.

4. Butterfly valve (10) according to claim 1, characterised in that the removable coupling part (40) comprises a boring (44) with the same diameter as the boring (14) in the valve housing (12).

5. Butterfly valve (10) according to claim 1, characterised in that the valve housing (12) is equipped with a neck (28) comprising a collar (30), and that an upper part (32) of the spindle extends up above the collar (30) and makes up a rotating pivot.

6. Butterfly valve (10) according to claim 1, characterised in that the valve housing (12) comprises, on one or both sides of the damper (16), bushes or bearings (34) for mounting of the spindle (18).

7. Butterfly valve (10) according to claim 1, characterised in that the valve housing (12) comprises an internal edge (36) on which the valve housing (20) lies, where said edge (36) and a contact surface (38) of a flange connection or the coupling part (40) are arranged to function as sealing surfaces, as the valve seat (20) is compressed between these parts to provide a leak proof connection.

8. Butterfly valve (10) according to claim 1, characterised in that the butterfly valve (10) is surface treated with hot-dip galvanising.
